(19) United States
(12) Patent Application Publication
(10) Pub. No.: US 2024/0229274 A9
(43) Pub. Date: Jul. 11, 2024

(54) METHOD OF REMOVING LEAD MATERIALS TO REGENERATE ANODE FOR MANUFACTURING COPPER FOIL

(71) Applicant: WESCO ELECTRODE CO., LTD., Changwon-si (KR)

(72) Inventors: Sang Wook KIM, Gyeongju-si (KR); Sang Soo KIM, Changwon-si (KR); Mi Jung PARK, Changwon-si (KR); Ju A KIM, Changwon-si (KR); Ji Hyun LEE, Changwon-si (KR)

(21) Appl. No.: 18/113,487

(22) Filed: Feb. 23, 2023

(30) Foreign Application Priority Data
Oct. 25, 2022 (KR) 10-2022-0138158

(51) Int. Cl. C25D 1/04; C25D 21/12

(52) U.S. Cl. CPC C25D 1/04; C25D 21/12

(57) ABSTRACT

Disclosed is a method of removing lead materials from an anode for manufacturing copper foil to regenerate the anode. The method includes cleaning solution preparation, anode cleaning and anode washing. The cleaning solution preparation includes preparing a cleaning solution containing an aqueous solution of EDTA and citric acid. The cleaning solution used to perform the anode cleaning has a pH of 7 to 9 and a temperature of 20 to 50° C. The anode cleaning includes cleaning the anode by immersing the anode including the lead materials attached to the surface thereof in the cleaning solution to perform EDTA-Pb chelation. As a result, the transfer of the lead materials from the anode to the cleaning solution means substantial removal of the lead materials from the anode. The anode, from which the lead materials have been removed, is washed using a high-pressure washer.

### CROSS-REFERENCE TO RELATED APPLICATION

This application claims priority under 35 U.S.C. § 119 to Korean Patent Application No. 10-2022-0138158, filed on Oct. 25, 2022, in the Korean Intellectual Property Office, the entire contents of which are hereby incorporated by reference.

### BACKGROUND OF THE INVENTION

### Field of the Invention

The present invention relates to a method of removing lead materials from an anode for manufacturing copper foil using electrolysis, and more particularly, to a method of removing lead materials from an anode for manufacturing copper foil to regenerate the anode by removing the lead materials from the anode using EDTA and citric acid.

### Description of the Related Art

Korean Patent Laid-open No. 10-2019-0038325 is an example of the prior patent associated with manufacturing of copper foil using electrolysis. In accordance with this prior patent, as shown in FIG. 1, a device including an insoluble anode 20 immersed in an electrolyte solution 12 of an electrolytic bath 10 and a rotating drum-shaped cathode is used to manufacture copper foil.

The insoluble anode 20 disposed to face the drum-shaped cathode 30 has a concave shape matching the cylindrical appearance of the drum-shaped cathode 30. When electricity is applied between the insoluble anode 20 and the drum-shaped cathode 30, a metal may grow on the surface of the drum-shaped cathode 30. Therefore, when the drum-shaped cathode 30 rotates with respect to the anode (plating electrode) 20 upon application of electricity, copper foil is formed on the drum-shaped cathode 30 based on electrolysis. The copper foil thus formed may be peeled off of the drum-shaped cathode 30 to continuously obtain copper foil.

In the process of producing copper foil described above, lead materials (PbO, PbO₂, and PbSO₄) are deposited and grown on the anode 20 for manufacturing copper foil. Deposition and growth of the lead materials in the process of manufacturing electrolytic copper foil may deteriorate the functions of the anode 20 for manufacturing copper foil and thus adversely affect the quality of the copper foil.

Therefore, it is necessary to isolate the anode 20 from the electrolytic bath and remove the lead materials from the surface of the anode 20. Although physical force may be used to remove the lead materials, this may disadvantageously cause physical damage to the surface of the anode. In another attempt, the lead materials may be removed by a chemical method, for example, by removing the lead materials using an acid.

However, an acid has drawbacks of poor working environment and non-environmental friendliness. Obviously, the treatment of wastewater containing used acid is environmentally and economically undesirable. Therefore, there is a need for a method for removing lead materials from the anode 20 for manufacturing copper foil that is capable of satisfying sufficient economic feasibility, efficiency, and environmental friendliness.

### SUMMARY OF THE INVENTION

Therefore, the present invention has been made in view of the above problems, and it is an object of the present invention to provide a method of removing lead materials from an anode for manufacturing copper foil that is capable of efficiently removing the lead materials from the anode using EDTA and citric acid.

In accordance with the present invention, the above and other objects can be accomplished by the provision of a method of removing lead materials attached to a surface of an anode for manufacturing copper foil having a concave shape matching a rotating drum-shaped cathode for manufacturing copper foil, the method including preparing a cleaning solution, cleaning the anode, and washing the anode.

The preparing the cleaning solution includes preparing a cleaning solution containing an aqueous solution of EDTA and a citric acid. The cleaning solution has a pH of 7 to 9 and a temperature of 20 to 50° C. and is used to perform the anode cleaning. The anode cleaning includes cleaning the anode by immersing the anode including the lead materials attached to the surface thereof in the cleaning solution to perform EDTA-Pb chelation. After transfer of the lead materials from the anode to the cleaning solution, the anode, from which the lead materials have been removed, is washed using a high-pressure washer.

In another embodiment, the method may further include recovering the lead materials from the cathode by electrolyzing the EDTA aqueous solution used to clean the anode.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a sectional view illustrating an example of a device for manufacturing electrolytic copper foil according to the prior patent; and

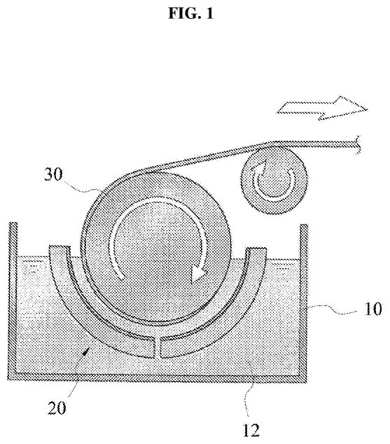

FIG. 2 is a flowchart illustrating a method of manufacturing electrolytic copper foil according to the present invention.

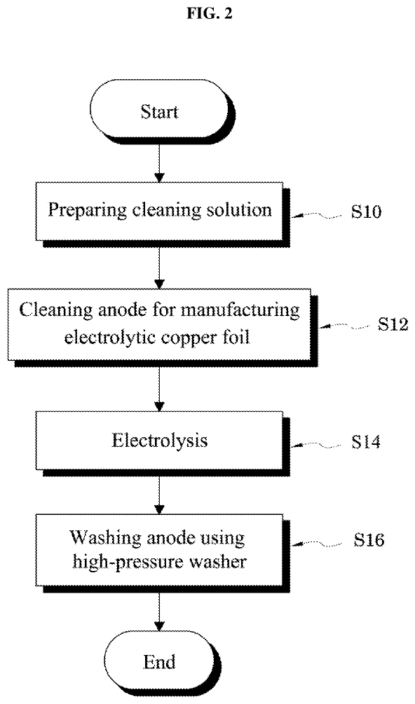

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

The method of removing lead materials according to the present invention starts with preparing a cleaning solution (S10). The cleaning solution used herein is used to remove lead materials attached to the surface of an anode for manufacturing electrolytic copper foil and is an aqueous solution of ethylenediaminetetraacetic acid (EDTA) and citric acid.

The EDTA used herein is EDTA-4N to ensure sufficient water solubility. In addition, EDTA-4N and citric acid are dissolved together in water to prepare a cleaning solution and the citric acid contained therein is used to adjust the pH of the cleaning solution. That is, the cleaning solution of the present invention is prepared by dissolving EDTA-4N and citric acid in water. At this time, the pH of the cleaning solution is adjusted within the range from 7 to 9 by controlling the amount of citric acid.

The adjusting the pH of the cleaning solution to be as weakly basic as possible enables efficient reaction between EDTA and metal cations. The reason for this is as follows. When the pH is higher than the upper limit defined above, the EDTA complex is unstable and OH⁻ competes with EDTA, thus disadvantageously forming a metal hydroxide precipitate or an unreactive complex. In addition, when the pH is lower than the lower limit defined above, EDTA having low water solubility is disadvantageously leached out.

The cleaning solution as described above is water containing EDTA-4N and citric acid, and has a pH within the range of 7 to 9. After the preparation of the cleaning solution (S10) is completed, electrode cleaning (S12) of cleaning the anode for manufacturing copper foil is performed. This cleaning process (S12) means cleaning the anode for manufacturing copper foil by immersing the anode in the cleaning solution described above.

When the anode for manufacturing copper foil is immersed in the cleaning solution as described above, chelation in which EDTA-4N is converted to EDTA-Pb occurs. That is, chelation occurs in which the lead in the lead materials attached to the surface of the anode for manufacturing copper foil is temporarily bonded to EDTA in the cleaning solution. This process means substantial removal of the lead materials from the anode for manufacturing copper foil.

Here, such a process may be depicted by the following reaction scheme of C₁₀H₁₂N₂Na₄O₈·4H₂O+PbO₂→EDTA-Pb, and the product is in a basic state and is chelated in the form of H₂ EDTA and remains dissolved in the cleaning solution. In this cleaning process, it is preferable to adjust the pH of the cleaning solution within the range defined above and to maintain the temperature at 20 to 50° C. In addition, this temperature range in the cleaning process is determined in consideration of the efficiency of the reaction and the convenience of water heating.

When the anode cleaning (S12) as described above is completed, the lead materials are substantially removed from the anode for manufacturing copper foil. That is, the lead materials isolated from the anode for manufacturing copper foil are present in the form of EDTA-Pb in the cleaning solution. In addition, since the lead materials are substantially removed from the anode for manufacturing copper foil, the anode can be reused after cleaning.

Since the lead materials are present in the EDTA solution of the cleaning solution, the lead materials in the solution must be removed in order to reuse the expensive EDTA solution. Therefore, electrolysis (S14) is performed to remove the lead materials from the cleaning solution. That is, when the cleaning solution in a chelated state as EDTA-Pb is subjected to electrolysis in an electrolytic bath, the lead materials can be recovered on the anode by plating. Here, the shape and configuration of the electrolytic bath are not limited and the electrolytic bath preferably includes a multi-stage of anode and cathode.

The attachment of lead materials to the cathode through the electrolysis means substantial removal of lead materials from the EDTA solution, which is a cleaning solution. When the lead materials are removed in this way, the expensive EDTA solution can be used again as a cleaning solution, thus having a great economical advantage. Therefore, the electrolysis (S14) enables substantial regeneration of the cleaning solution containing EDTA.

In addition, the anode for manufacturing electrolytic copper foil, from which the lead materials have been removed through the anode cleaning (S12) is completely regenerated by washing the anode with water using a high-pressure washer through the anode washing (S16). It will be obvious to those skilled in the art that this post-treatment is not limited to washing using a high-pressure washer and may be performed using various methods.

As is apparent from the above description, the method of removing lead materials from the anode for manufacturing copper foil according to the present invention has advantages of simply and efficiently removing the lead materials attached to the anode. This means that the method of the present invention is capable of regenerating the anode for manufacturing copper foil such that the anode performs normal reaction.

In addition, according to another embodiment of the present invention, the lead component is recovered again from the aqueous solution, from which the lead materials have been removed, so that the expensive EDTA aqueous solution can be reused, which is economically advantageous. It is efficient and preferable to recover the lead component contained in the cleaning solution from the cathode through electrolysis.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of removing lead materials attached to a surface of an anode for manufacturing copper foil having a concave shape matching a rotating drum-shaped cathode for manufacturing copper foil, the method comprising:
preparing a cleaning solution containing an aqueous solution of EDTA and citric acid;
cleaning the anode by immersing the anode including the lead materials attached to the surface thereof in the cleaning solution to perform EDTA-Pb chelation; and
washing the anode, from which the lead materials have been removed, using a high-pressure washer,
wherein the cleaning solution has a pH of 7 to 9 and a temperature of 20 to 50° C.

2. The method according to claim 1, further comprising:
recovering the lead materials from the cathode by electrolyzing the EDTA aqueous solution used to clean the anode.
